(19) United States
(12) Patent Application Publication
(10) Pub. No.: US 2022/0316470 A1
(43) Pub. Date: Oct. 6, 2022

(54) Fuel Pump

(71) Applicant: Hitachi Astemo, Ltd., Hitachinaka-shi, Ibaraki (JP)

(72) Inventors: Satoshi USUI, Hitachinaka-shi (JP); Hiroyuki YAMADA, Hitachinaka-shi (JP); Kiyotaka OGURA, Hitachinaka-shi (JP)

(21) Appl. No.: 17/596,875

(22) PCT Filed: Aug. 14, 2020
(86) PCT No.: PCT/JP2020/030844

§ 371 Date: Dec. 20, 2021

(30) Foreign Application Priority Data
Sep. 11, 2019 (JP) 2019-165075

(51) Int. Cl. F04B 53/14; F04B 53/10

(52) U.S. Cl. CPC F04B 53/144; F04B 53/10

(57) ABSTRACT

Provided is a fuel pump capable of improving productivity. According to the present invention, a fuel pump includes a pump body 1, a plunger 2, an electromagnetic suction valve 3, and a relief valve 4. The plunger 2 reciprocates in a first room 1a which is a columnar space portion provided in the pump body 1. The electromagnetic suction valve 3 causes fuel to be sucked into a pressurizing chamber 11 formed by the first room 1a and the plunger 2. When the fuel pressure on the downstream side of the pressurizing chamber 11 exceeds a set value, the relief valve 4 opens, and brings the fuel back to the pressurizing chamber 11. The pump body 1 includes a second room 1b in which the relief valve 4 is disposed, and a communication hole 1e for causing the first room 1a and the second room 1b to communicate with each other. The diameter of the communication hole 1e is equal to the diameter of the first room 1a.

### TECHNICAL FIELD

The present invention relates to a fuel pump that supplies fuel to an engine at high pressure.

### BACKGROUND ART

A fuel pump is disclosed in PTL 1, for example. The high-pressure fuel supply pump disclosed in PTL 1 includes a housing, a suction valve, a discharge valve, and a relief valve. The housing includes a cylinder that accommodates a cylinder liner that slidably holds a plunger and is a stepped space that forms a pressurizing chamber. The suction valve is opened in a state where no current is supplied to an electromagnetic solenoid. When a current is supplied to the electromagnetic solenoid, the suction valve is opened to cause the fuel to be sucked into the pressurizing chamber.

The discharge valve is assembled to a discharge valve accommodating portion of the housing. The discharge valve accommodating portion communicates with the pressurizing chamber via a fuel discharge hole. The high-pressure fuel pressurized in the pressurizing chamber is supplied to the discharge valve. The discharge valve is opened when the pressure of the supplied fuel becomes equal to or higher than predetermined pressure, and the fuel that has passed through the discharge valve is pressure-fed to an accumulator.

The relief valve is assembled to a relief valve accommodating portion of the housing. The relief valve accommodating portion communicates with a high-pressure region on the downstream side of the discharge valve and communicates with the pressurizing chamber via a communication passage. The relief valve is opened when the pressure of the fuel in the high-pressure region becomes equal to or higher than specific pressure, and thus, brings the high-pressure fuel back to the pressurizing chamber.

### CITATION LIST

### Patent Literature

PTL 1: JP 2019-2374 A

### SUMMARY OF INVENTION

### Technical Problem

However, the high-pressure fuel supply pump disclosed in PTL 1 has a complicated shape of an intersection portion between the pressurizing chamber and the communication passage. Therefore, the processing of the communication passage becomes complicated, and thus improvement in productivity of the high-pressure fuel supply pump is hindered.

An object of the present invention is to provide a fuel pump capable of improving productivity in consideration of the above problems.

### Solution to Problem

In order to solve the above problems and achieve the object of the present invention, according to the present invention, a fuel pump includes a pump body, a plunger, a suction valve, and a relief valve. The plunger reciprocates in a first room which is a columnar space portion provided in the pump body. The suction valve causes fuel to be sucked into a pressurizing chamber formed by the first room and the plunger. When the fuel pressure on the downstream side of the pressurizing chamber exceeds a set value, the relief valve opens, and brings the fuel back to the pressurizing chamber. The pump body includes a second room in which the relief valve is disposed, and a communication hole for causing the first room and the second room to communicate with each other. The diameter of the communication hole is equal to the diameter of the first room, and the communication hole extends the first room.

### Advantageous Effects of Invention

According to the fuel pump having the above configuration, it is possible to improve productivity.

Objects, configurations, and advantageous effects other than those described above will be clarified by the descriptions of the following embodiments.

### BRIEF DESCRIPTION OF DRAWINGS

FIG. 1 is an overall configuration diagram illustrating a fuel supply system using a high-pressure fuel supply pump according to an embodiment of the present invention.

FIG. 2 is a longitudinal cross-sectional view (part 1) of the high-pressure fuel supply pump according to the embodiment of the present invention.

FIG. 3 is a longitudinal cross-sectional view (part 2) of the high-pressure fuel supply pump according to the embodiment of the present invention.

FIG. 4 is a horizontal cross-sectional view of the high-pressure fuel supply pump according to the embodiment of the present invention when viewed from the top.

FIG. 5 is a longitudinal cross-sectional view (part 3) of the high-pressure fuel supply pump according to the embodiment of the present invention.

### DESCRIPTION OF EMBODIMENTS

### 1. Embodiment

Hereinafter, a high-pressure fuel supply pump according to an embodiment of the present invention will be described.

In the drawings, the common members are denoted by the same reference signs.

### [Fuel Supply System]

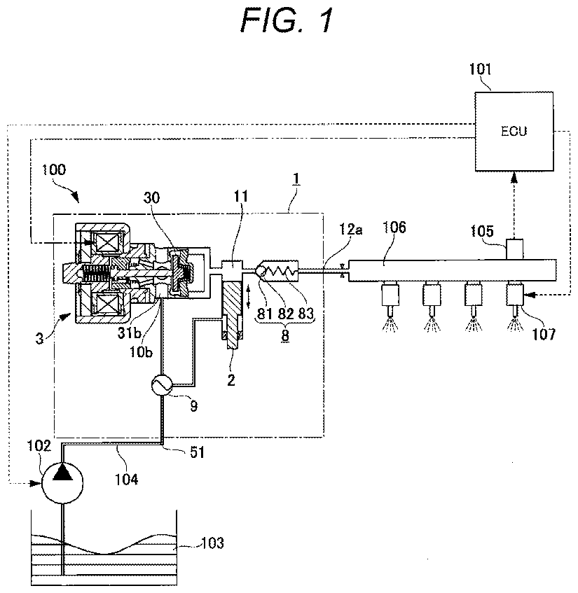

Next, a fuel supply system using the high-pressure fuel supply pump (fuel pump) according to the present embodiment will be described with reference to FIG. 1.

FIG. 1 is an overall configuration diagram illustrating the fuel supply system using the high-pressure fuel supply pump according to the embodiment.

As illustrated in FIG. 1, the fuel supply system includes a high-pressure fuel supply pump (fuel pump) 100, an engine control unit (ECU) 101, a fuel tank 103, a common rail 106, and a plurality of injectors 107. The components of the high-pressure fuel supply pump 100 are integrally incorporated in the pump body 1.

The fuel in the fuel tank 103 is pumped up by a feed pump 102 that drives based on a signal from the ECU 101. The pumped fuel is pressurized to appropriate pressure by a pressure regulator (not illustrated) and fed to a low-pressure fuel suction port 51 of the high-pressure fuel supply pump 100 through a low-pressure pipe 104.

The high-pressure fuel supply pump 100 pressurizes the fuel supplied from the fuel tank 103 and pressure-feeds the fuel to the common rail 106. The plurality of injectors 107 and a fuel pressure sensor 105 are mounted on the common rail 106. The plurality of injectors 107 are mounted in accordance with the number of cylinders (combustion chambers), and inject fuel in accordance with a drive current output from the ECU 101. In the present embodiment, the fuel supply system is a so-called direct injection engine system in which the injector 107 directly injects fuel into a cylinder of the engine.

The fuel pressure sensor 105 outputs the detected pressure data to the ECU 101. The ECU 101 calculates an appropriate injection fuel amount (target injection fuel length), appropriate fuel pressure (target fuel pressure), and the like based on engine state quantities (for example, a crank rotation angle, a throttle opening degree, an engine rotational speed, and fuel pressure) obtained from various sensors.

In addition, the ECU 101 controls driving of the high-pressure fuel supply pump 100 and the plurality of injectors 107 based on the calculation result of the fuel pressure (target fuel pressure) and the like. That is, the ECU 101 includes a pump control unit that controls the high-pressure fuel supply pump 100 and an injector control unit that controls the injector 107.

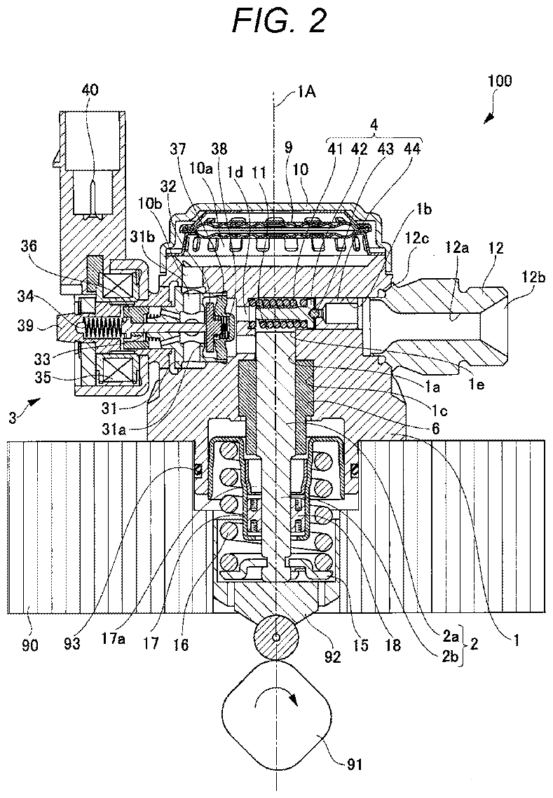

The high-pressure fuel supply pump 100 includes a pressure pulsation reduction mechanism 9, an electromagnetic suction valve 3 which is a variable capacity mechanism, a relief valve 4 (see FIG. 2), and a discharge valve 8. The fuel flowing from the low-pressure fuel suction port 51 reaches a suction port 31b of the electromagnetic suction valve 3 via the pressure pulsation reduction mechanism 9 and a suction passage 10b.

The fuel flowing into the electromagnetic suction valve 3 passes through a valve portion 32, flows through a suction passage 1d formed in the pump body 1, and then flows into the pressurizing chamber 11. The plunger 2 is reciprocally inserted into the pressurizing chamber 11. Power is transmitted to the plunger 2 by a cam 91 (see FIG. 2) of the engine, and thus the plunger 2 reciprocates.

In the pressurizing chamber 11, fuel is sucked from the electromagnetic suction valve 3 in a downward stroke of the plunger 2, and the fuel is pressurized in an upward stroke. When the fuel pressure in the pressurizing chamber 11 exceeds a predetermined value, the discharge valve 8 is opened, and the high-pressure fuel is pressure-fed to the common rail 106 via a discharge passage 12a. The fuel discharge by the high-pressure fuel supply pump 100 is operated by opening and closing the electromagnetic suction valve 3. The opening and closing of the electromagnetic suction valve 3 is controlled by the ECU 101.

### [High-Pressure Fuel Supply Pump]

Next, a configuration of the high-pressure fuel supply pump 100 will be described with reference to FIGS. 2 to 5.

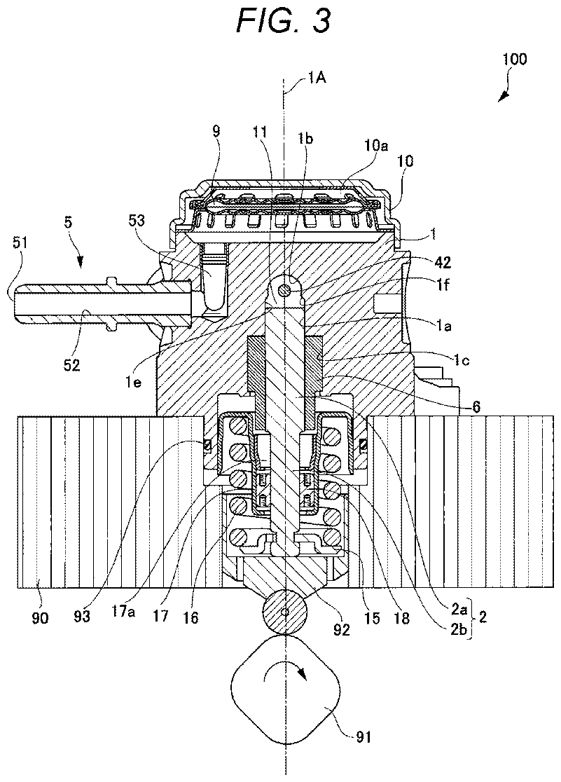

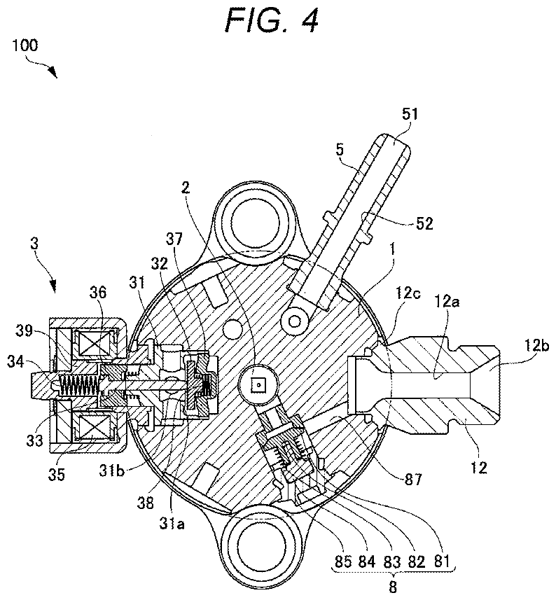

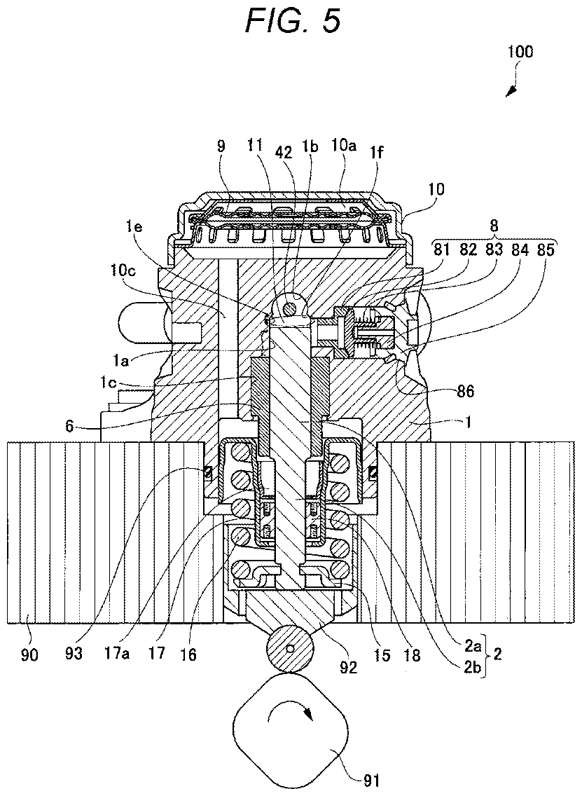

FIG. 2 is a longitudinal cross-sectional view (part 1) of the high-pressure fuel supply pump 100 when viewed in a cross section perpendicular to a horizontal direction. FIG. 3 is a longitudinal cross-sectional view (part 2) of the high-pressure fuel supply pump 100 when viewed in a cross section perpendicular to the horizontal direction. FIG. 4 is a horizontal cross-sectional view of the high-pressure fuel supply pump 100 when viewed in a cross section perpendicular to a vertical direction. FIG. 5 is a longitudinal cross-sectional view (part 3) of the high-pressure fuel supply pump 100 when viewed in a cross section perpendicular to the horizontal direction.

As illustrated in FIGS. 2 to 5, the pump body 1 of the high-pressure fuel supply pump 100 is formed in a substantially columnar shape. As illustrated in FIGS. 2 and 3, the pump body 1 includes a first room 1a, a second room 1b, a third room 1c, and the suction passage 1d. The pump body 1 is in close contact with a fuel pump attachment portion 90 and is fixed by a plurality of bolts (screws) (not illustrated).

The first room 1a is a columnar space portion provided in the pump body 1. The center line 1A of the first room 1a coincides with the center line of the pump body 1. One end of the plunger 2 is inserted into the first room 1a, and the plunger 2 reciprocates in the first room 1a. The first room 1a and the one end of the plunger 2 form the pressurizing chamber 11.

The second room 1b is a columnar space portion provided in the pump body 1. The center line of the second room 1b is perpendicular to the center line of the pump body 1 (first room 1a). The relief valve 4 is disposed in the second room 1b. The diameter of the second room 1b is smaller than the diameter of the first room 1a.

The first room 1a and the second room 1b communicate with each other through a circular communication hole 1e. The diameter of the communication hole 1e is equal to the diameter of the first room 1a. The communication hole 1e extends one end of the first room 1a. The diameter of the communication hole 1e is greater than the outer diameter of the plunger 2. The center line of the communication hole 1e is perpendicular to the center line of the second room 1b.

As illustrated in FIGS. 3 and 5, the diameter of the communication hole 1e is greater than the diameter of the second room 1b. The communication hole 1e has a tapered surface 1f having a diameter that decreases toward the second room 1b in a cross section perpendicular to the center line of the second room 1b. Thus, the fuel that has passed through the relief valve 4 disposed in the second room 1b can be smoothly brought back to the pressurizing chamber 11 along the tapered surface 1f.

The third room 1c is a columnar space portion provided in the pump body 1 and is continuous with the other end of the first room 1a. The center line of the third room 1c coincides with the center line 1A of the first room 1a and the center line of the pump body 1. The diameter of the third room 1c is greater than the diameter of the first room 1a. A cylinder 6 that guides the reciprocation of the plunger 2 is disposed in the third room 1c.

The cylinder 6 is formed in a tubular shape, and is press-fitted into the third room 1c of the pump body 1 on the outer peripheral side thereof. One end of the cylinder 6 abuts on the top surface (step portion between the first room 1a and the third room 1c) of the third room 1c. The plunger 2 is slidably in contact with the inner peripheral surface of the cylinder 6.

An O-ring 93 showing a specific example of a seat member is interposed between the fuel pump attachment portion 90 and the pump body 1. The O-ring 93 prevents engine oil from leaking to the outside of the engine (internal combustion engine) through a space between the fuel pump attachment portion 90 and the pump body 1.

A tappet 92 that converts a rotational motion of the cam attached to a cam shaft of the engine into an up-down motion and transfers the up-down motion to the plunger 2 is provided at the lower end of the plunger 2. The plunger 2 is biased toward the cam 91 by a spring 16 via a retainer 15, and is crimped to the tappet 92. The tappet 92 reciprocates with the rotation of the cam 91. The plunger 2 reciprocates together with the tappet 92 to change the volume of the pressurizing chamber 11.

A seal holder 17 is disposed between the cylinder 6 and the retainer 15. The seal holder 17 is formed in a tubular shape into which the plunger 2 is inserted, and has an auxiliary room 17a at the upper end portion on the cylinder 6 side. The seal holder 17 holds a plunger seal 18 at the lower end portion on the retainer 15 side.

The plunger seal 18 is slidably in contact with the outer periphery of the plunger 2. When the plunger 2 reciprocates, the plunger seal 18 seals the fuel in the auxiliary room 17a, and thus the fuel in the auxiliary room 17a does not flow into the engine. In addition, the plunger seal 18 prevents lubricating oil (including engine oil) that lubricates a sliding portion in the engine from flowing into the pump body 1.

In FIG. 2, the plunger 2 reciprocates in an up-down direction. When the plunger 2 descends, the volume of the pressurizing chamber 11 increases. When the plunger 2 rises, the volume of the pressurizing chamber 11 decreases.

That is, the plunger 2 is disposed to reciprocate in a direction of enlarging and reducing the volume of the pressurizing chamber 11.

The plunger 2 has a large-diameter portion 2a and a small-diameter portion 2b. When the plunger 2 reciprocates, the large-diameter portion 2a and the small-diameter portion 2b are located in the auxiliary room 17a. Therefore, the volume of the auxiliary room 17a increases or decreases by the reciprocation of the plunger 2.

The auxiliary room 17a communicates with a low-pressure fuel room 10 through a fuel passage 10c (see FIG. 5). When the plunger 2 descends, the fuel flows from the auxiliary room 17a to the low-pressure fuel room 10. When the plunger 2 rises, the fuel flows from the low-pressure fuel room 10 to the auxiliary room 17a. Thus, it is possible to reduce the fuel flow rate into and out of the pump in the suction stroke or the return stroke of the high-pressure fuel supply pump 100, and it is possible to reduce pressure pulsation generated in the high-pressure fuel supply pump 100.

As illustrated in FIG. 3, the low-pressure fuel room 10 is provided at the upper portion of the pump body 1 of the high-pressure fuel supply pump 100. A suction joint 5 is attached to a side surface portion of the pump body 1. The suction joint 5 is connected to a low-pressure pipe 104 through which fuel supplied from the fuel tank 103 (see FIG. 1) passes. The fuel in the fuel tank 103 is supplied from the suction joint 5 into the pump body 1.

The suction joint 5 includes the low-pressure fuel suction port 51 connected to the low-pressure pipe 104 and a suction flow path 52 communicating with the low-pressure fuel suction port 51. The fuel that has passed through the suction flow path 52 passes through a suction filter 53 provided inside the pump body 1, and then is supplied to the low-pressure fuel room 10. The suction filter 53 removes foreign substances in the fuel and prevents entering of foreign substances into the high-pressure fuel supply pump 100.

The low-pressure fuel room 10 is provided with a low-pressure fuel flow path 10a and the suction passage 10b (see FIG. 2). The pressure pulsation reduction mechanism 9 is provided in the low-pressure fuel flow path 10a. When the fuel flowing into the pressurizing chamber 11 is brought back to the suction passage 10b through the electromagnetic suction valve 3 which is again in a valve open state, the pressure pulsation is generated in the low-pressure fuel room 10. The pressure pulsation reduction mechanism 9 reduces spreading of the pressure pulsation generated in the high-pressure fuel supply pump 100 to the low-pressure pipe 104.

The pressure pulsation reduction mechanism 9 is formed by a metal diaphragm damper in which two corrugated disk-shaped metal plates are bonded to each other at the outer periphery thereof, and an inert gas such as argon is injected. The metal diaphragm damper of the pressure pulsation reduction mechanism 9 expands and contracts to absorb or reduce the pressure pulsation.

The suction passage 10b communicates with the suction port 31b (see FIG. 2) of the electromagnetic suction valve 3. The fuel passing through the low-pressure fuel flow path 10a reaches the suction port 31b of the electromagnetic suction valve 3 via the suction passage 10b.

As illustrated in FIGS. 2 and 4, the electromagnetic suction valve 3 is inserted into a lateral hole formed in the pump body 1. The electromagnetic suction valve 3 includes a suction-valve seat 31 press-fitted into the lateral hole formed in the pump body 1, a valve portion 32, a rod 33, a rod biasing spring 34, an electromagnetic coil 35, and an anchor 36.

The suction-valve seat 31 is formed in a tubular shape, and a seating portion 31a is provided on an inner peripheral portion. The suction port 31b that reaches the inner peripheral portion from the outer peripheral portion is formed in the suction-valve seat 31. The suction port 31b communicates with the suction passage 10b in the low-pressure fuel room 10 described above.

A stopper 37 facing the seating portion 31a of the suction-valve seat 31 is disposed in the lateral hole formed in the pump body 1. The valve portion 32 is disposed between the stopper 37 and the seating portion 31a. The valve biasing spring 38 is interposed between the stopper 37 and the valve portion 32.

The valve biasing spring 38 biases the valve portion 32 toward the seating portion 31a.

When the valve portion 32 abuts on the seating portion 31a, a communicating portion between the suction port 31b and the pressurizing chamber 11 is closed, and the electromagnetic suction valve 3 turns into the valve close state. On the other hand, when the valve portion 32 abuts on the stopper 37, the communicating portion between the suction port 31b and the pressurizing chamber 11 is opened, and the electromagnetic suction valve 3 turns into the valve open state.

The rod 33 penetrates a cylindrical hole of the suction-valve seat 31, and one end thereof abuts on the valve portion 32. The rod biasing spring 34 biases the valve portion 32 in a valve opening direction which is the stopper 37 side, via the rod 33. One end of the rod biasing spring 34 is engaged with the other end of the rod 33, and the other end of the rod biasing spring 34 is engaged with a magnetic core 39 disposed to surround the rod biasing spring 34.

The anchor 36 faces the end face of the magnetic core 39. The anchor 36 is engaged with a flange provided in an intermediate portion of the rod 33. The electromagnetic coil 35 is disposed around the magnetic core 39. A terminal member 40 is electrically connected to the electromagnetic coil 35, and a current flows through the terminal member 40.

In a non-energized state in which no current flows through the electromagnetic coil 35, the rod 33 is biased in the valve opening direction by the biasing force of the rod biasing spring 34, and presses the valve portion 32 in the valve opening direction.

As a result, the valve portion 32 is separated from the seating portion 31a and abuts on the stopper 37, and thus the electromagnetic suction valve 3 turns into the valve open state. That is, the electromagnetic suction valve 3 is a normally open type that opens in the non-energized state.

In the valve open state of the electromagnetic suction valve 3, the fuel in the suction port 31b passes between the valve portion 32 and the seating portion 31a, passes through a plurality of fuel passage holes (not illustrated) of the stopper 37 and the suction passage 1d, and then flows into the pressurizing chamber 11. In the valve open state of the electromagnetic suction valve 3, the valve portion 32 comes into contact with the stopper 37, and thus the position of the valve portion 32 in the valve opening direction is regulated. A gap between the valve portion 32 and the seating portion 31a in the valve open state of the electromagnetic suction valve 3 means a movable range of the valve portion 32, and this is a valve opening stroke.

When a current flows through the electromagnetic coil 35, the anchor 36 is attracted in a valve closing direction by a magnetic attraction force of the magnetic core 39. As a result, the anchor 36 moves against the biasing force of the rod biasing spring 34 and comes into contact with the magnetic core 39. When the anchor 36 moves in the valve closing direction on the magnetic core 39 side, the rod 33 with which the anchor 36 is engaged moves together with the anchor 36. As a result, the valve portion 32 is released from the biasing force in the valve opening direction, and moves in the valve closing direction by the biasing force of the valve biasing spring 38. When the valve portion 32 comes into contact with the seating portion 31a of the suction-valve seat 31, the electromagnetic suction valve 3 turns into a valve close state.

As illustrated in FIGS. 4 and 5, the discharge valve 8 is connected to the outlet side (downstream side) of the pressurizing chamber 11. The discharge valve 8 includes a discharge-valve seat 81 communicating with the pressurizing chamber 11, a valve portion 82 that is in contact with and separated from the discharge-valve seat 81, a discharge valve spring 83 for biasing the valve portion 82 toward the discharge-valve seat 81, and a discharge valve stopper 84 that determines a stroke (moving distance) of the valve portion 82.

The discharge valve 8 includes a plug 85 that blocks leakage of fuel to the outside. The discharge valve stopper 84 is press-fitted into the plug 85. The plug 85 is joined to the pump body 1 by welding at a welded portion 86. The discharge valve 8 communicates with a discharge valve chamber that is opened and closed by the valve portion 82. The discharge valve chamber 87 is formed in the pump body 1.

The pump body 1 is provided with a lateral hole communicating with the second room 1b (see FIG. 2), and a discharge joint 12 is inserted into the lateral hole. The discharge joint 12 includes the above-described discharge passage 12a communicating with the lateral hole of the pump body 1 and the discharge valve chamber 87, and a fuel discharge port 12b which is one end of the discharge passage 12a. The fuel discharge port 12b of the discharge joint 12 communicates with the common rail 106. The discharge joint 12 is fixed to the pump body 1 by welding by a welded portion 12c.

In a state where there is no difference in fuel pressure (fuel differential pressure) between the pressurizing chamber 11 and the discharge valve chamber 87, the valve portion 82 is pressed against the discharge-valve seat 81 by the biasing force of the discharge valve spring 83, and thus the discharge valve 8 turns into the valve close state. When the fuel pressure in the pressurizing chamber 11 becomes greater than the fuel pressure in the discharge valve chamber 87, the valve portion 82 moves against the biasing force of the discharge valve spring 83, and thus the discharge valve 8 turns into the valve open state.

When the discharge valve 8 is in the valve close state, the (high-pressure) fuel in the pressurizing chamber 11 passes through the discharge valve 8 and reaches the discharge valve chamber 87. Then, the fuel that has reached the discharge valve chamber 87 is discharged to the common rail 106 (see FIG. 1) via the fuel discharge port 12b of the discharge joint 12. With the above configuration, the discharge valve 8 functions as a check valve that restricts a flowing direction of the fuel.

The relief valve 4 illustrated in FIG. 2 is a valve configured to operate and bring the fuel in the discharge passage 12a back to the pressurizing chamber 11, when some problem occurs in the common rail 106 or a member ahead of the common rail 106, and thus the common rail becomes a high pressure exceeding a predetermined pressure. The relief valve 4 is disposed at a position higher than the discharge valve 8 (see FIG. 5) in the direction in which the plunger 2 reciprocates (up-down direction).

The relief valve 4 includes a relief spring 41, a relief-valve holder 42, a valve portion 43, and a seat member 44. The relief valve 4 is inserted from the discharge joint 12 and disposed in the second room 1b. One end portion of the relief spring 41 abuts on the pump body 1 (one end of the second room 1b), and the other end portion abuts on the relief-valve holder 42. The relief-valve holder 42 is engaged with the valve portion 43. The biasing force of the relief spring 41 acts on the valve portion 43 via the relief-valve holder 42.

The valve portion 43 is pressed by the biasing force of the relief spring 41 to close the fuel passage of the seat member 44. The movement direction of the valve portion 43 (relief-valve holder 42) is perpendicular to the direction in which the plunger 2 reciprocates. The center line of the relief valve 4 (the center line of the relief-valve holder 42) is perpendicular to the center line of the plunger 2.

The seat member 44 includes a fuel passage facing the valve portion 43, and a side of the fuel passage on an opposite side of the valve portion 43 communicates with the discharge passage 12a. The movement of the fuel between the pressurizing chamber 11 (upstream side) and the seat member 44 (downstream side) is blocked when the valve portion 43 comes into contact (close contact) with the seat member 44 to close the fuel passage.

When the pressure in the common rail 106 or a member ahead of the common rail increases, the fuel on the seat member 44 side presses the valve portion 43 and moves the valve portion 43 against the biasing force of the relief spring 41. As a result, the valve portion 43 is opened, and the fuel in the discharge passage 12a is brought back to the pressurizing chamber 11 through the fuel passage of the seat member 44. Therefore, the pressure for opening the valve portion 43 is determined by the biasing force of the relief spring 41.

The movement direction of the valve portion 43 (relief-valve holder 42) in the relief valve 4 is different from the movement direction of the valve portion 82 in the discharge valve 8 described above. That is, the movement direction of the valve portion 82 in the discharge valve 8 is a first radial direction of the pump body 1. The movement direction of the valve portion 43 in the relief valve 4 is a second radial direction different from the first radial direction of the pump body 1. Thus, it is possible to dispose the discharge valve 8 and the relief valve 4 at positions that do not overlap each other in the up-down direction, and it is possible to reduce the size of the pump body 1 by effectively utilizing the space inside the pump body 1.

### [Operation of High-Pressure Fuel Pump]

Next, an operation of the high-pressure fuel pump according to the present embodiment will be described with reference to FIGS. 2 and 4.

In FIG. 2, when the plunger 2 descends, and the electromagnetic suction valve 3 is opened, the fuel flows from the suction passage 1d into the pressurizing chamber 11. A stroke in which the plunger 2 descends is referred to as a suction stroke below. On the other hand, when the plunger 2 rises, and the electromagnetic suction valve 3 is closed, the fuel in the pressurizing chamber 11 is pressurized, passes through the discharge valve 8, and is pressure-fed to the common rail 106 (see FIG. 1). A stroke in which the plunger 2 rises is referred to as an upward stroke below.

As described above, if the electromagnetic suction valve 3 is closed during a rising process, the fuel sucked into the pressurizing chamber 11 during the suction stroke is pressurized and discharged to the common rail 106 side. On the other hand, if the electromagnetic suction valve 3 is opened during the rising process, the fuel in the pressurizing chamber 11 is pushed back toward the suction passage 1d and is not discharged toward the common rail 106. As described above, the fuel discharge by the high-pressure fuel supply pump 100 is operated by opening and closing the electromagnetic suction valve 3. The opening and closing of the electromagnetic suction valve 3 is controlled by the ECU 101.

In the suction stroke, the volume of the pressurizing chamber 11 increases, and the fuel pressure in the pressurizing chamber 11 decreases. Thus, the fluid differential pressure (referred to as “fluid differential pressure before and after the valve portion 32” below) between the suction port 31b and the pressurizing chamber 11 is reduced. When the biasing force of the rod biasing spring 34 becomes larger than the fluid differential pressure before and after the valve portion 32, the rod 33 moves in the valve opening direction, the valve portion 32 is separated from the seating portion 31a of the suction-valve seat 31, and the electromagnetic suction valve 3 turns into the valve open state.

When the electromagnetic suction valve 3 is in the valve open state, the fuel in the suction port 31b passes between the valve portion 32 and the seating portion 31a, passes through a plurality of fuel passage holes (not illustrated) of the stopper 37, and then flows into the pressurizing chamber 11. In the valve open state of the electromagnetic suction valve 3, the valve portion 32 comes into contact with the stopper 37, and thus the position of the valve portion 32 in the valve opening direction is regulated. A gap between the valve portion 32 and the seating portion 31a in the valve open state of the electromagnetic suction valve 3 means a movable range of the valve portion 32, and this is a valve opening stroke.

After the suction stroke is ended, the stroke proceeds to the upward stroke. At this time, the electromagnetic coil remains in the non-energized state. Thus, no magnetic attraction force acts between the anchor 36 and the magnetic core 39. A biasing force in the valve opening direction in accordance with a difference in biasing force between the rod biasing spring 34 and the valve biasing spring 38 and a force pressing in the valve closing direction by a fluid force generated when the fuel flows back from the pressurizing chamber 11 to the low-pressure fuel flow path 10a act on the valve portion 32.

In this state, in order for the electromagnetic suction valve 3 to maintain the valve open state, the difference in the biasing force between the rod biasing spring 34 and the valve biasing spring 38 is set to be larger than the fluid force. The volume of the pressurizing chamber 11 decreases as the plunger 2 rises. Therefore, the fuel sucked into the pressurizing chamber 11 passes between the valve portion 32 and the seating portion 31a again, and is brought back to the suction port 31b. Thus, the pressure in the pressurizing chamber 11 does not increase. Such a stroke is referred to as a return stroke.

In the return process, when a control signal from the ECU 101 (see FIG. 1) is applied to the electromagnetic suction valve 3, a current flows through the electromagnetic coil 35 via the terminal member 40. When a current flows in the electromagnetic coil 35, a magnetic attractive force acts between the magnetic core 39 and the anchor 36, and the anchor (rod 33) is attracted to the magnetic core 39. As a result, the anchor 36 (rod 33) moves in the valve closing direction (direction away from the valve portion 32) against the biasing force by the rod biasing spring 34.

When the anchor 36 (rod 33) moves in the valve closing direction, the valve portion 32 is released from the biasing force in the valve opening direction, and moves in the valve closing direction by the biasing force of the valve biasing spring 38 and the fluid force caused by the fuel flowing into the suction passage 10b. When the valve portion 32 comes into contact with the seating portion 31a of the suction-valve seat (the valve portion 32 is seated on the seating portion 31a), the electromagnetic suction valve 3 turns into the valve close state.

After the electromagnetic suction valve 3 is in the valve close state, the fuel in the pressurizing chamber 11 is pressurized as the plunger 2 rises. When the pressure of the fuel becomes equal to or higher than predetermined pressure, the fuel passes through the discharge valve 8 and is discharged to the common rail 106 (see FIG. 1). This stroke is referred to as a discharge process. That is, the upward stroke from the lower start point to the upper start point of the plunger 2 includes the return stroke and the discharge stroke. By controlling the timing of energizing the electromagnetic coil 35 of the electromagnetic suction valve 3, it is possible to control the amount of high-pressure fuel to be discharged.

If the timing of energizing the electromagnetic coil 35 is made earlier, the ratio of the return stroke during the upward stroke becomes smaller, and the ratio of the discharge stroke becomes larger. As a result, the amount of fuel brought back to the suction passage 10b decreases, and the amount of fuel discharged at high pressure increases. On the other hand, if the timing of energizing the electromagnetic coil 35 is delayed, the ratio of the return stroke during the upward stroke increases, and the ratio of the discharge stroke decreases. As a result, the amount of fuel brought back to the suction passage 10b increases, and the amount of fuel discharged at a high pressure decreases. As described above, by controlling the timing of energizing the electromagnetic coil 35, it is possible to control the amount of fuel discharged at high pressure to an amount required by the engine (internal combustion engine).

### 2. Summary

As described above, the high-pressure fuel supply pump 100 (fuel pump) according to the above-described embodiment includes the pump body 1 (pump body), the plunger 2 (plunger), the electromagnetic suction valve 3 (suction valve), and the relief valve 4 (relief valve). The plunger 2 reciprocates in the first room 1a (first room) which is a columnar space portion provided in the pump body 1. The electromagnetic suction valve 3 causes fuel to be sucked into the pressurizing chamber 11 (pressurizing chamber) formed by the first room 1a and the plunger 2. When the fuel pressure on the downstream side of the pressurizing chamber 11 exceeds a set value, the relief valve 4 opens, and brings the fuel back to the pressurizing chamber 11. The pump body 1 includes a second room 1b (second room) in which the relief valve 4 is disposed, and a communication hole 1e (communication hole) for causing the first room 1a and the second room 1b to communicate with each other. The diameter of the communication hole 1e is equal to the diameter of the first room 1a.

When holes such as the first room 1a, the second room 1b, and the communication hole 1e are processed in the pump body 1, unnecessary protrusions (burrs) are generated on the processed surface. When the protrusion (burr) is left, an error occurs in the dimension of the hole, and adverse effects such as failure to attach the component and injury occur when the protrusion (burr) is touched. Therefore, it is necessary to remove the protrusion (burr). In the embodiment described above, since the diameter of the communication hole 1e is equal to the diameter of the first room 1a, it is possible to easily process the communication hole 1e and to easily remove the protrusion (burr). In addition, it is possible to prevent the shape of the pump body 1 from becoming complicated. Therefore, it is possible to improve the productivity of the pump body 1 and the high-pressure fuel supply pump 100 and to reduce the cost.

Since the diameter of the communication hole 1e is equal to the diameter of the first room 1a, the fuel easily flows from the relief valve 4 to the pressurizing chamber 11, and thus it is possible to improve the relief performance. Furthermore, since the relief valve is directly incorporated in the second room 1b provided in the pump body 1, it is possible to omit a housing (seat member) for storing components constituting the relief valve. Thus, it is possible to reduce the number of components and to reduce the cost.

In the high-pressure fuel supply pump 100 (fuel pump) according to the embodiment described above, the second room 1b (second room) is a columnar space portion, and the diameter of the second room 1b is smaller than the diameter of the communication hole 1e (communication hole). Thus, it is possible to cause the fuel flowing from the relief valve 4 to the pressurizing chamber 11 to easily pass through the communication hole 1e, and to improve the relief performance.

In addition, the communication hole 1e (communication hole) of the high-pressure fuel supply pump 100 (fuel pump) according to the embodiment described above has the tapered surface 1f (tapered surface) having a diameter that decreases toward the second room 1b in the cross section perpendicular to the center line of the second room 1b (second room). Thus, it is possible to smoothly bring the fuel that has passed through the relief valve 4 disposed in the second room 1b back to the pressurizing chamber 11 along the tapered surface 1f.

In the high-pressure fuel supply pump 100 (fuel pump) according to the above-described embodiment, the center line of the communication hole 1e (communication hole) is perpendicular to the center line of the second room 1b (second room). Thus, it is possible to cause the fuel that has passed through the relief valve 4 disposed in the second room 1b to efficiently pass through the communication hole 1e, and to prevent hindrance of improvement in relief performance. In addition, it is possible to prevent the shape of the pump body from becoming complicated, and to improve the productivity of the pump body 1 and the high-pressure fuel supply pump 100.

In the high-pressure fuel supply pump 100 (fuel pump) according to the above-described embodiment, the diameter of the communication hole 1e (communication hole) is greater than the outer diameter of the plunger 2 (plunger). Thus, it is possible to improve the durability of the plunger 2 without an occurrence of a situation in which the plunger 2 reciprocating in the pressurizing chamber 11 collides with the periphery of the communication hole 1e.

The high-pressure fuel supply pump 100 (fuel pump) according to the above-described embodiment includes the discharge joint 12 (discharge joint) attached to the pump body (pump body) on the downstream side of the pressurizing chamber 11 (pressurizing chamber). The relief valve 4 (relief valve) is inserted into the second room 1b (second room) from the discharge joint 12. Thus, it is possible to easily dispose the relief valve 4 in the second room 1b, and to improve the workability of an assembly work of the high-pressure fuel supply pump 100. In addition, it is not necessary to newly provide a hole for forming the relief valve into the second room 1b in the pump body 1, and it is possible to prevent the shape of the pump body 1 from becoming complicated.

In the high-pressure fuel supply pump 100 (fuel pump) according to the above-described embodiment, the movement direction of the valve portion 43 (valve portion) in the relief valve 4 (relief valve) is perpendicular to the direction in which the plunger 2 (plunger) reciprocates. Thus, it is possible to prevent the second room 1b for disposing the relief valve 4 from extending in the direction in which the plunger 2 reciprocates. As a result, it is possible to reduce the length of the pump body 1 in the direction in which the plunger 2 reciprocates, and to reduce the size of the pump body 1.

The high-pressure fuel supply pump 100 (fuel pump) according to the above-described embodiment includes the discharge valve 8 (discharge valve) arranged on the downstream side of the pressurizing chamber 11 (pressurizing chamber). The movement direction of the valve portion 82 (valve portion) in the discharge valve 8 is different from the movement direction of the valve portion 43 (valve portion) in the relief valve 4 (relief valve). The relief valve 4 is disposed at the position higher than the discharge valve 8 in the up-down direction in which the plunger 2 (plunger) reciprocates. Thus, even when the discharge valve 8 and the relief valve 4 partially overlap each other in a direction perpendicular to the up-down direction, it is possible to prevent interference between the discharge valve 8 and the relief valve 4, and to reduce the size of the pump body 1 by effectively utilizing the space in the pump body 1.

The pump body 1 (pump body) of the high-pressure fuel supply pump 100 (fuel pump) according to the embodiment described above is formed in a substantially columnar shape, and the center of the first room 1a (first room) coincides with the center of the pump body 1. The movement direction of the valve portion 82 (valve portion) in the discharge valve 8 (discharge valve) is the first radial direction of the pump body 1. The movement direction of the valve portion 43 (valve portion) in the relief valve 4 (relief valve) is the second radial direction different from the first radial direction of the pump body 1. Thus, it is possible to dispose the discharge valve 8 and the relief valve 4 at positions that do not overlap each other in the movement direction (up-down direction) of the plunger 2, and it is possible to reduce the size of the pump body 1 by effectively utilizing the space inside the pump body 1.

The pump body 1 (pump body) of the high-pressure fuel supply pump 100 (fuel pump) according to the embodiment described above includes the third room 1c (third room) that communicates with the first room 1a (first room) and has a diameter greater than the first room 1a. In the third room 1c, the cylinder 6 (cylinder) through which the plunger 2 (plunger) slidably passes is disposed. Thus, it is possible to cause the end surface of the cylinder 6 to abut on the step portion between the first room 1a and the third room 1c, and to prevent the cylinder 6 from being shifted toward the first room 1a.

Hitherto, the fuel pump according to the embodiment of the present invention has been described above including the operational effects thereof. However, the fuel pump in the present invention is not limited to the above-described embodiment, and various modifications can be made without departing from the gist of the invention described in the claims. The above-described embodiment is described in detail in order to explain the present invention in an easy-to-understand manner, and the above embodiment is not necessarily limited to a case including all the described configurations.

For example, in the above-described embodiment, the movement direction of the valve portion 32 in the electromagnetic suction valve 3 is set to the second radial direction, which is the same as the movement direction of the valve portion 43 in the relief valve 4 (see FIG. 2). However, the movement direction of the valve portion in the relief valve according to the present invention may be different from the movement direction of the valve portion in the electromagnetic suction valve. For example, in the fuel pump according to the present invention, the movement direction of the valve portion in the relief valve, the movement direction of the valve portion in the electromagnetic suction valve, and the movement direction of the valve portion in the discharge valve may all be different.

### REFERENCE SIGNS LIST

1 pump body
1a first room
1b second room
1c third room
1d suction passage
1e communication hole
1f tapered surface
1A center line
2 plunger
3 electromagnetic suction valve
4 relief valve
5 suction joint
6 cylinder
8 discharge valve
9 pressure pulsation reduction mechanism
10 low-pressure fuel room
11 pressurizing chamber
12 discharge joint
31 suction-valve seat
31a seating portion
31b suction port
32 valve portion
33 rod
35 electromagnetic coil
36 anchor
37 stopper
39 magnetic core
40 terminal member
42 relief-valve holder
43 valve portion
44 seat member
81 discharge-valve seat
82 valve portion
84 discharge valve stopper
85 plug
100 high-pressure fuel supply pump (fuel pump)
101 ECU
102 feed pump
103 fuel tank
104 low-pressure pipe
105 fuel pressure sensor
106 common rail
107 injector

1. A fuel pump comprising:
a pump body;
a plunger that reciprocates in a first room that is a columnar space portion provided in the pump body;
a suction valve that causes fuel to be sucked into a pressurizing chamber formed by the first room and the plunger; and
a relief valve that when fuel pressure on a downstream side of the pressurizing chamber exceeds a set value, opens, and brings fuel back to the pressurizing chamber,
wherein
the pump body includes a second room in which the relief valve is disposed, and a communication hole for causing the first room and the second room to communicate with each other, and
a diameter of the communication hole is equal to a diameter of the first room.

2. The fuel pump according to claim 1, wherein
the second room is a columnar space portion, and
a diameter of the second room is smaller than the diameter of the communication hole.

3. The fuel pump according to claim 2, wherein the communication hole has a tapered surface having a diameter that decreases toward the second room in a cross section perpendicular to a center line of the second room.

4. The fuel pump according to claim 2, wherein a center line of the communication hole is perpendicular to a center line of the second room.

5. The fuel pump according to claim 1, wherein the diameter of the communication hole is greater than an outer diameter of the plunger.

6. The fuel pump according to claim 1, further comprising:
a discharge joint attached to the pump body on the downstream side of the pressurizing chamber,
wherein the relief valve is inserted into the second room from the discharge joint.

7. The fuel pump according to claim 1, wherein a movement direction of a valve portion of the relief valve is perpendicular to a direction in which the plunger reciprocates.

8. The fuel pump according to claim 1, further comprising:
a discharge valve disposed on the downstream side of the pressurizing chamber,
wherein
a movement direction of a valve portion of the discharge valve is different from a movement direction of a valve portion of the relief valve, and
the relief valve is disposed at a position higher than the discharge valve in an up-down direction being a direction in which the plunger reciprocates.

9. The fuel pump according to claim 8, wherein
the pump body is formed in a substantially columnar shape,
a center of the first room coincides with a center of the pump body,
the movement direction of the valve portion of the discharge valve is a first radial direction of the pump body, and
the movement direction of the valve portion of the relief valve is a second radial direction different from the first radial direction of the pump body.

10. The fuel pump according to claim 1, wherein
the pump body includes a third room that communicates with the first room and has a diameter greater than a diameter of the first room, and
a cylinder through which the plunger slidably penetrates is disposed in the third room.
